(19) United States
(12) Patent Application Publication
(10) Pub. No.: US 2023/0196171 A1
(43) Pub. Date: Jun. 22, 2023

(54) OPTIMIZING QUANTUM PROCESSING BY QUBIT TYPE

(71) Applicant: Red Hat, Inc., Raleigh, NC (US)

(72) Inventors: Leigh Griffin, Waterford (IE); Stephen Coady, Waterford (IE)

(21) Appl. No.: 17/557,637

(22) Filed: Dec. 21, 2021

(51) Int. Cl. G06N 10/60; G06N 10/20

(52) U.S. Cl. CPC G06N 10/60; G06N 10/20

(57) ABSTRACT

Optimizing quantum processing by qubit type is provided herein. In particular, a classical computing system receives a first quantum service request executable by a quantum computing system, including a plurality of quantum computing devices. Each quantum computing device of the plurality of quantum computing devices includes a plurality of qubits of a qubit type. The classical computing system provides the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits. The classical computing system receives, from each simulator process of the plurality of simulator processes, first simulation results of execution of the first quantum service request.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

### SUMMARY

The examples disclosed herein provide optimizing quantum processing by qubit type. In particular, a classical computing system receives a first quantum service request executable by a quantum computing system, including a plurality of quantum computing devices. Each quantum computing device of the plurality of quantum computing devices includes a plurality of qubits of a qubit type. The classical computing system provides the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits. The classical computing system receives, from each simulator process of the plurality of simulator processes, first simulation results of execution of the first quantum service request.

The method includes receiving, by a classical computing system that includes one or more processor devices, a first quantum service request executable by a quantum computing system that includes a plurality of quantum computing devices. Each quantum computing device of the plurality of quantum computing devices includes a plurality of qubits of a qubit type. The method further includes providing, by the classical computing system, the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits. The method further includes receiving, by the classical computing system from each simulator process of the plurality of simulator processes, first simulation results of execution of the first quantum service request.

In another implementation, a classical computing system is disclosed. The classical computing system includes a processor device. The processor device is to receive a first quantum service request executable by a quantum computing system, including a plurality of quantum computing devices. Each quantum computing device of the plurality of quantum computing devices includes a plurality of qubits of a qubit type. The processor device is further to provide the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits. The processor device is further to receive, from each simulator process of the plurality of simulator processes, first simulation results of execution of the first quantum service request.

In another implementation, a computer program product is disclosed. The computer program product is stored on a non-transitory computer-readable storage medium and includes instructions to cause a processor device of a classical computing system to receive a first quantum service request executable by a quantum computing system, including a plurality of quantum computing devices. Each quantum computing device of the plurality of quantum computing devices includes a plurality of qubits of a qubit type. The instructions further cause the processor device to provide the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits. The instructions further cause the processor device to receive, from each simulator process of the plurality of simulator processes, first simulation results of execution of the first quantum service request.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a system to optimize quantum processing by qubit type, according to one example;

FIG. 1B is a block diagram of the system of FIG. 1A, illustrating simulation of multiple quantum service requests, according to one example;

FIG. 2 is a flowchart of a method to optimize quantum processing by qubit type, according to one example;

FIG. 3 is a simplified block diagram of the processor device illustrated in FIG. 1A, according to one implementation;

FIG. 4 is a block diagram of a computing device suitable for implementing one or more of the processing devices disclosed herein, according to one implementation; and

FIG. 5 is a block diagram of a quantum computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Quantum hardware utilizes different qubit types, which may be made from physically different materials. Accordingly, different qubit types may perform differently depending on execution type, environmental condition, or the like.

In this regard, the examples herein disclose a classical computing service to optimize quantum processing by qubit type. In particular, the classical computing service may simulate executing a quantum service request by a plurality of simulator processes, each simulator process representing a different quantum computing device. In this way, the classical computing service may optimize quantum processing by qubit type and/or by quantum computing device, such as if multiple quantum computing devices utilize the same qubit type. In certain implementations, the classical computing service may optimize quantum processing of multiple quantum service requests across multiple qubit types and/or multiple quantum computing devices.

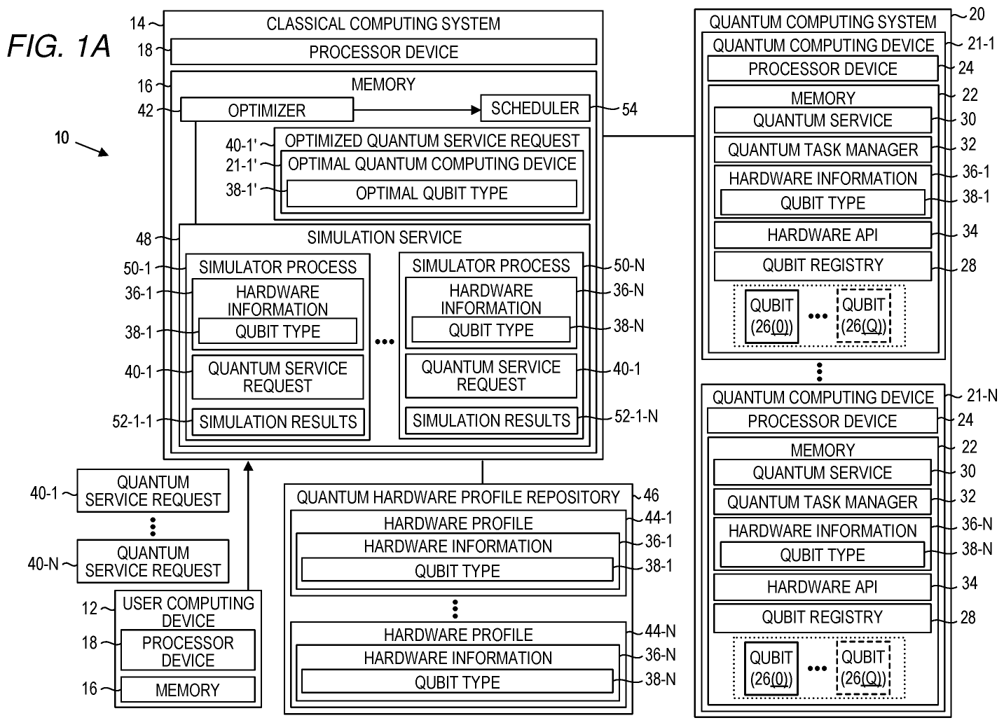

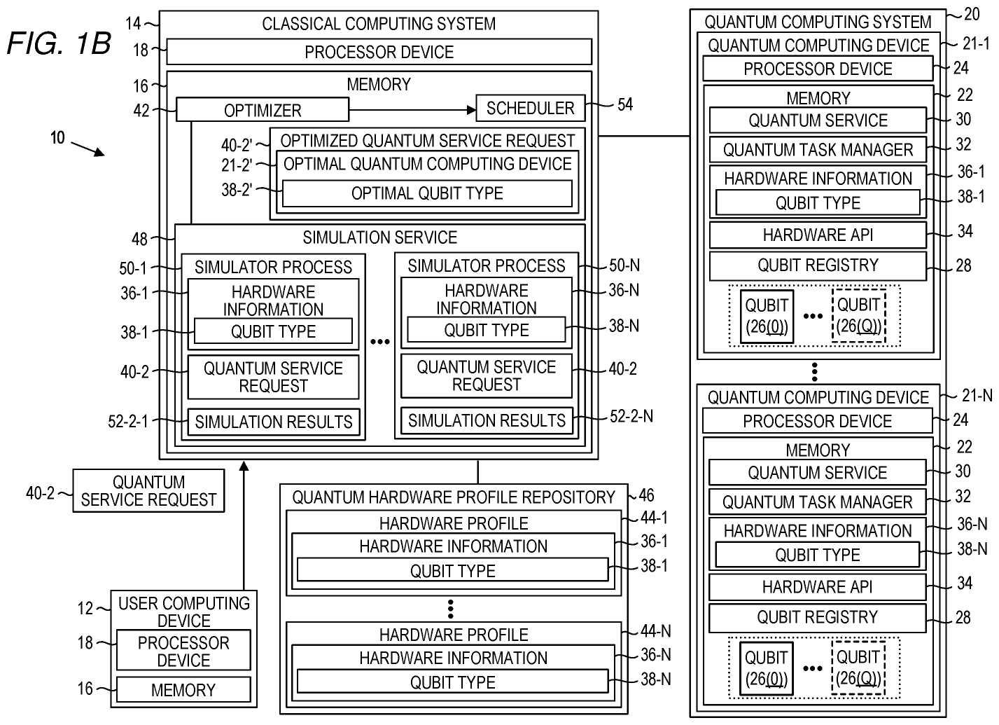

FIG. 1A is a block diagram of a computing system 10 according to one example. The computing system 10 includes a user computing device 12 and a classical computing system 14, which are classical computing devices including a memory 16 and a processor device 18. In certain implementations, the classical computing system 14 includes functionality provided by the user computing device 12. The computing system 10 includes a quantum computing system 20 with a plurality of quantum computing devices 21-1-21-N (generally referred to as quantum computing devices 21) that each include a system memory 22 and a processor device 24. The quantum computing devices 21 may also be referred to as quantum machines 21. The user computing device 12, the classical computing system 14, and/or the quantum computing system 20 are all communicatively coupled via a classical communications link (not shown), which may include a private network or a public network such as the internet. It is to be understood that the computing system 10, according to some examples, may include other quantum computing devices and/or classical computing devices that are not illustrated in FIG. 1A. Additionally, the user computing device 12, the classical computing system 14, and/or the quantum computing system 20 in some examples may include constituent elements in addition to those illustrated.

In the example of FIG. 1A, each quantum computing device 21 implements a set of one or more qubits 26(0)-26(Q) (referred to generally as qubits 26) for use by quantum services executed by the quantum computing device 21. To maintain information for the qubit(s) 26, the quantum computing devices 21 may each include a qubit registry 28, which includes a plurality of qubit registry entries, each corresponding to a qubit such as the one or more qubits 26. The qubit registry 28 maintains and provides access to data relating to the qubits implemented by the quantum computing device 21, such as a count of the total number of qubits implemented by the quantum computing device 21 and a count of the number of available qubits that are currently available for allocation, as non-limiting examples. Each of the qubit registry entries of the qubit registry 28 also stores qubit metadata for a corresponding qubit 26. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an entanglement indicator that indicates whether the corresponding qubit is in an entangled state.

The quantum computing device 21 executes one or more quantum services 30. The quantum service 30 is a process that executes on a quantum computing device 21 and employs qubits 26 to provide desired functionality. The quantum service 30 is defined using a quantum service definition, such as provided by a quantum assembly (QASM) file, which includes one or more quantum programming instructions. QASM is a programming language that specifies quantum circuits as input to a quantum computer by declaring classical bits and qubits and describing operations on the qubits and measurements needed to obtain a classical result based on the qubits.

Execution of quantum services 30 is facilitated by a quantum task manager 32, which handles operations for creating, monitoring, and terminating quantum services 30. The quantum task manager 32 may provide an interface (not shown) through which other services or tasks may request specific information regarding the qubits 26, the quantum service 30, and/or the quantum computing device 21. Additionally, information regarding the status and functionality of the quantum computing device 21 and the elements thereof may be made accessible to other processes via a hardware application programming interface (API) 34.

Each quantum computing device 21 includes a physical enclosure containing qubits 26. Further, each quantum computing device 21 includes hardware information 36-1-36-N (referred to generally as hardware information 36), including a qubit type 38-1-38-N (referred to generally as qubit type 38). Generally, each quantum computing device 21 includes one qubit type 38, but in certain implementations, the quantum computing device 21 may include multiple qubit types 38. Qubit types 38 may be made of physically different material, which makes the qubits 26 better suited for certain execution types and/or environmental conditions.

Hardware information 36 may include load, operating temperature, noise, error rate, last time rebooted, hardware load, or the like. The hardware information 36 may be general or time-sensitive information. For example, the hardware information 36 may include load-based parameters, such as a low processing load threshold, a high processing load threshold, a low qubit usage threshold, a high qubit usage threshold, a low application queue threshold, a high application queue threshold, or the like. Hardware information 36 may include event-based parameters, such as low operating temperature threshold, high operating temperature threshold, or the like. Hardware information 36 may further include global operating parameters, such as a time, time period, processing load, available memory, count of executing processes, application queue, qubit usage, count of available qubits 26, and/or operating temperature, or the like. The hardware information 36 may include global operating conditions, such as system load, system response time, operating temperature, state of the qubits (e.g., qubit age, coherence time, and/or the like), or the like.

Qubits 26 generally require very specific environmental conditions for operation. Quantum runs can vary significantly depending on operating conditions of the quantum computing device 21, such as processing load, temperature variance, maintenance schedule, implementation strategy, or the like. Further, such quantum runs vary depending on qubit type 38. The qubit type 38 may include qubits 26 with various types of physical supports, including photon, coherent state of light, electrons, nucleus, optical lattices, Josephson junction, singly charged quantum dot pair, quantum dot, gapped topological system, van der Waals heterostructure, or the like. Further, the qubit type 38 may include information support, including polarization of light, fock state, time of arrival, quadrature, spin, charge, current, energy, braiding of excitations, or the like.

The user computing device 12 transmits a quantum service request 40-1-40-N (referred to generally as quantum service request 40). In particular, in certain implementations, the user computing device 12 transmits a single quantum service request 40. In other implementations, the user computing device 12 transmits multiple quantum service requests 40. Further, in certain implementations, the origination of the quantum service requests 40 is within the classical computing system 14.

As noted above, quantum runs can vary significantly depending on operating conditions of the quantum computing device 21 and/or the qubit type 38. Accordingly, an optimizer 42 simulates execution of the quantum service request 40 to identify a qubit type 38 and/or a quantum computing device 21 to optimize execution of the quantum service request 40.

The optimizer 42 receives and processes the quantum service request 40. To simulate the quantum service request 40, the optimizer 42 retrieves hardware profiles 44-1-44-N (referred to generally as hardware profiles 44) from a quantum hardware profile repository 46. Each hardware profile 44 corresponds to a different quantum computing device 21. In particular, each hardware profile 44 includes hardware information 36, including qubit type 38. In certain implementations, the hardware profiles 44 are updated in real time based on the operating conditions and/or environmental conditions of the quantum computing devices 21.

The optimizer 42 retrieves the hardware profiles 44 and forwards the hardware profiles 44 to a simulation service 48 to instantiate simulator processes 50-1-50-N (referred to generally as simulator process 50) based on the hardware profiles 44. In certain implementations, the optimizer 42 retrieves the hardware information 36 directly from the quantum computing device 21, such as through an hardware API 34, in real time. In this way, each simulator process 50 corresponds to a different quantum computing device 21. In certain implementations, the simulator process 50 corresponds to a simulator container. The container provides an operating environment that is isolated from other processes executing on the classical computing system 14, and to which predefined levels of system resources (e.g., memory, processor cycles, system bandwidth, and the like) of the classical computing system 14 may be allocated. The term “container” as used herein refers to a standalone, executable package of a piece of software that includes all resources to run the software, including code, runtime, system libraries, and settings, and that is implemented via a containerization technology, such as, by way of non-limiting example, Docker containerization technology or Linux LXC containerization technology, or the like.

The optimizer 42 inputs the quantum service request 40 into each simulator process 50. Each simulator process 50 then runs the quantum service request 40 to simulate the operating and/or environmental conditions of the respective quantum computing device 21. The simulator process 50 may utilize a Qiskit quantum computing framework, which is an open-source framework that provides tools for creating and manipulating quantum programs and services and simulating execution of the quantum programs and services on classical computing devices. The simulator process 50 is capable of taking as input a QASM file and simulating quantum operations or computations in a manner that may recreate the functionality of a quantum service 30. Within the simulator process 50, the quantum service request 40 is executed based on the hardware information 36.

Each simulator process 50 generates simulation results 52-1-1-52-1-N (referred to generally as simulation results 52-1). These simulation results 52-1 provide a baseline for the entire execution of the quantum service request 40. In certain implementations, the simulator process 50 is generated in real time based on the real-time performance characteristics of the quantum computing device 21. Different quantum computing devices 21 will process and be affected by the quantum service request 40 differently, such as depending on hardware information 36 and/or qubit type 38. Simulation results 52-1 may include execution time, errors, system impact, environmental impact, operating temperature, noise, or the like. For example, simulation results 52-1 may include load-based parameters, event-based parameters, global operating parameters, global operating conditions, or the like. Global operating parameters may include time, time period, processing load, available memory, count of executing processes, application queue, qubit usage, count of available qubits 26, and/or operating temperature, or the like. Global operating conditions may include system load, system response time, operating temperature, state of the qubits (e.g., qubit age, coherence time, and/or the like), or the like.

In certain implementations, the optimizer 42 forwards the simulation results 52-1 to the user computing device 12 for processing. In other implementations, the optimizer 42 automatically determines the optimal qubit type 38 and/or quantum computing device 21 to process the quantum service request 40. For example, in certain implementations, the optimizer 42 optimizes based on fastest execution time, fewest errors, minimized system impact, and/or minimized environmental impact across the quantum computing system, or the like.

The optimizer 42 receives and processes the simulation results 52-1 and determines an optimal qubit type 38 and/or quantum computing device 21 to execute the quantum service request 40-1. For example, in certain implementations, the optimizer 42 determines the optimal qubit type 38 but is agnostic to which quantum computing device 21 executes the quantum service request 40-1. In certain implementations, the optimizer 42 determines the optimal qubit type 38, and then, if there are multiple quantum computing devices 21 including the qubit type 38, further determines an optimal quantum computing device 21 of a plurality of quantum computing devices 21 to execute the quantum service request 40-1.

The optimizer 42 modifies the quantum service request 40-1 to generate an optimized quantum service request 40-1′ identifying the optimal quantum computing device 21-1′ and/or the optimal qubit type 38-1′. In certain implementations, the optimizer 42 does not modify the quantum service request 40-1 but instead sends the quantum service request 40-1 along with the identified optimal qubit type 38-1′ and/or optimal quantum computing device 21-1′. The optimizer 42 then forwards the optimized quantum service request 40-1′ to a scheduler 54, which manages the routing of the quantum service requests 40 to the quantum computing system 20.

FIG. 1B is a block diagram of the system of FIG. 1A illustrating simulation of multiple quantum service requests 40 according to one example. In particular, the optimizer receives a second quantum service request 40-2. The optimizer 42 may instantiate a new simulator process 50 even for the same quantum computing devices 21, such as to incorporate real-time operating conditions and/or environmental conditions. Each simulator process 50 runs the quantum service request 40-2 to generate simulation results 52-2-1-52-2-N (referred to generally as simulation results 52-2). The optimizer 42 analyzes the simulation results 52-2 to determine an optimal qubit type 38-2′ and/or optimal quantum computing device 21-2′. Accordingly, the optimizer 42 modifies the quantum service request 40-2 to generate an optimized quantum service request 40-2′ that identifies the optimal qubit type 38-2′ and/or optimal quantum computing device 21-2′.

In certain implementations, the optimizer 42 concurrently processes multiple quantum service requests 40-1, 40-2 and optimizes execution of the multiple quantum service requests 40-1, 40-2 across multiple quantum computing devices 21. For example, the optimizer 42 may optimize execution by the quantum computing system 20 for the fastest execution time, fewest errors, minimized system impact, and/or minimized environmental impact across the quantum computing system 20.

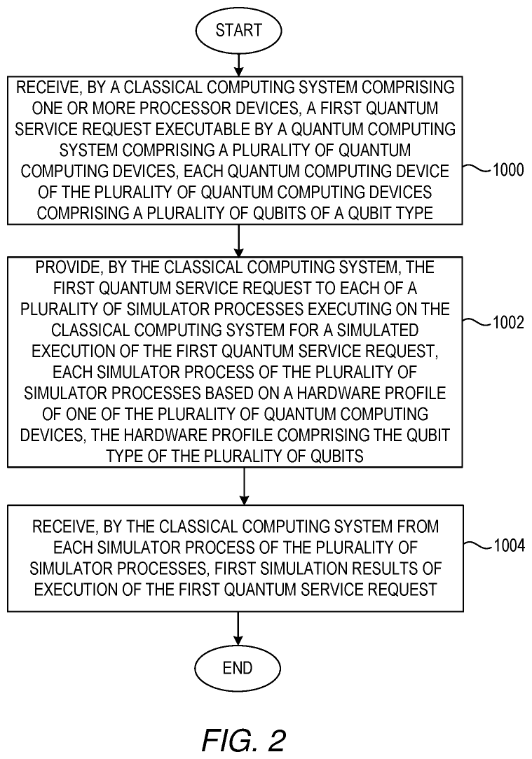

FIG. 2 is a flowchart of a method to optimize quantum processing by qubit type 38 according to one example. FIG. 2 will be discussed in conjunction with FIG. 1A. A classical computing system receives a first quantum service request executable by a quantum computing system, including a plurality of quantum computing devices. Each quantum computing device of the plurality of quantum computing devices includes a plurality of qubits of a qubit type (1000). The classical computing system provides the first quantum service request to each of a plurality of simulator processes executing on the classical computing system for a simulated execution of the first quantum service request. Each simulator process of the plurality of simulator processes is based on a hardware profile of one of the plurality of quantum computing devices. The hardware profile includes the qubit type of the plurality of qubits (1002). The classical computing system receives, from each simulator process of the plurality of simulator processes, first simulation results of execution of the first quantum service request (1004).

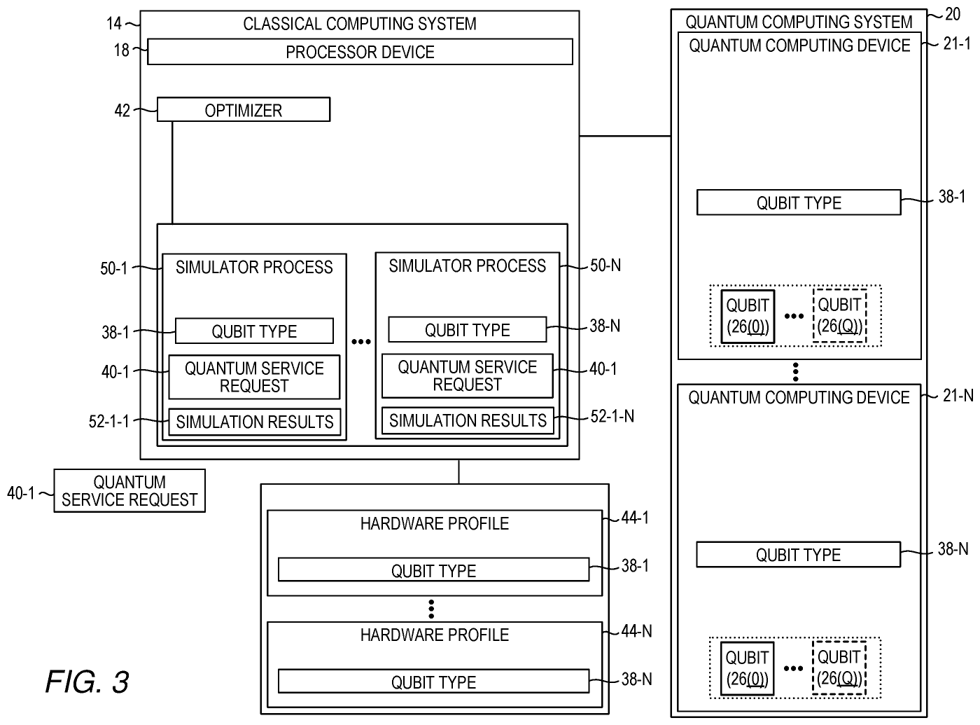

FIG. 3 is a simplified block diagram of the processor device illustrated in FIG. 1A, according to one implementation. In this example, the system includes a classical computing system 14 with a processor device 18. The classical computing system 14 receives a first quantum service request 40-1 executable by a quantum computing system 20, including a plurality of quantum computing devices 21-1. Each quantum computing device 21 of the plurality of quantum computing devices 21 includes a plurality of qubits 26 of a qubit type 38. The classical computing system 14 provides the first quantum service request 40-1 to each of a plurality of simulator processes 50 executing on the classical computing system 14 for a simulated execution of the first quantum service request 40-1. Each simulator process 50 of the plurality of simulator processes 50 is based on a hardware profile 44 of one of the plurality of quantum computing devices 21. The hardware profile 44 includes the qubit type 38 of the plurality of qubits 26. The classical computing system 14 receives, from each simulator process of the plurality of simulator processes 50, first simulation results 52-1-1-52-1-N of execution of the first quantum service request 40-1.

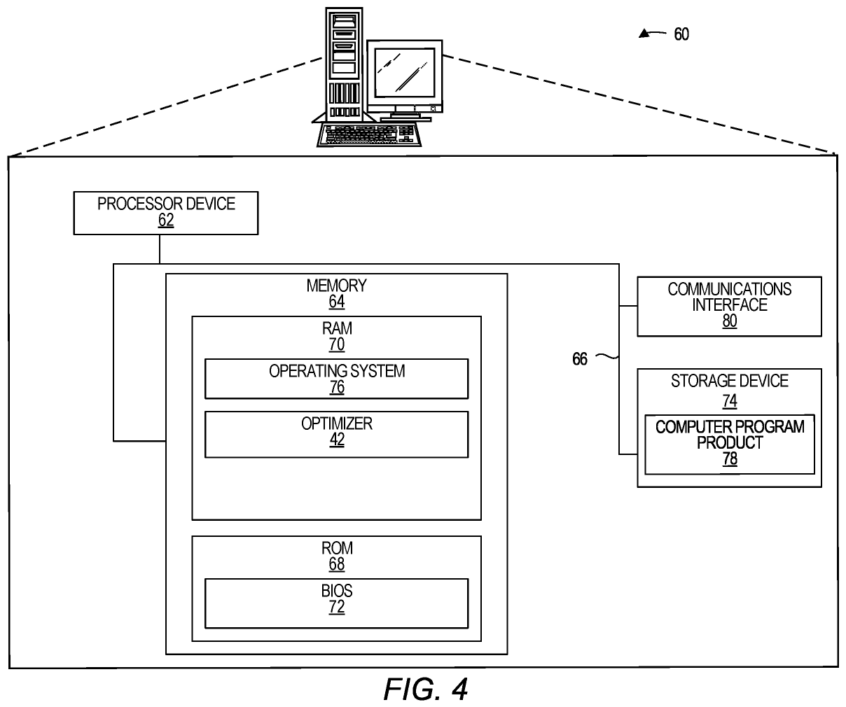

FIG. 4 is a block diagram of a computing device 60 containing components suitable for implementing any of the processing devices disclosed herein. The computing device 60 includes a processor device 62, a system memory 64, and a system bus 66. The system bus 66 provides an interface for system components including, but not limited to, the system memory 64 and the processor device 62. The processor device 62 can be any commercially available or proprietary processor.

The system bus 66 may be any of several types of bus structures that may further interconnect to a memory bus (with or without a memory controller), a peripheral bus, and/or a local bus using any of a variety of commercially available bus architectures. The system memory 64 may include non-volatile memory 68 (e.g., read-only memory (ROM), erasable programmable read-only memory (EPROM), electrically erasable programmable read-only memory (EEPROM), or the like), and volatile memory 70 (e.g., random-access memory (RAM)). A basic input/output system (BIOS) 72 may be stored in the non-volatile memory 68 and can include the basic routines that help transfer information between elements within the computing device 60. The volatile memory 70 may also include a high-speed RAM, such as static RAM, for caching data.

The computing device 60 may further include or be coupled to a non-transitory computer-readable storage medium such as storage device 74, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 74 and other drives associated with computer-readable media and computer-usable media may provide non-volatile storage of data, data structures, computer-executable instructions, and the like.

A number of modules can be stored in the storage device 74 and in the volatile memory 70, including an operating system 76 and one or more program modules, which may implement the functionality described herein in whole or in part. All or a portion of the examples herein may be implemented as a computer program product 78 stored on a transitory or non-transitory computer-usable or computer-readable storage medium, such as the storage device 74, which includes complex programming instructions, such as complex computer-readable program code, to cause the processor device 62 to carry out the steps described herein. Thus, the computer-readable program code can comprise software instructions for implementing the functionality of the examples described herein when executed on the processor device 62. The processor device 62, in conjunction with the network manager in the volatile memory 70, may serve as a controller or control system for the computing device 60 that is to implement the functionality described herein.

The computing device 60 may also include one or more communication interfaces 80, depending on the particular functionality of the computing device 60. The communication interfaces 80 may comprise one or more wired Ethernet transceivers, wireless transceivers, fiber, satellite, and/or coaxial interfaces by way of non-limiting examples.

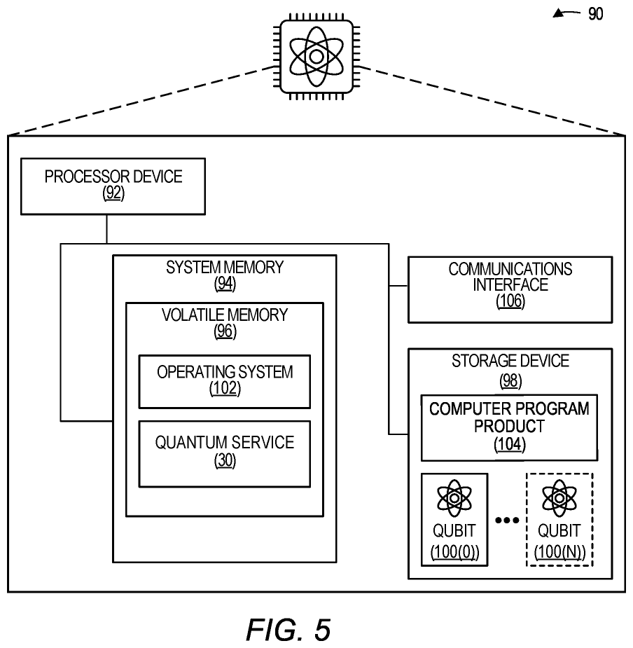

FIG. 5 is a block diagram of a quantum computing device 90, such as the quantum computing device 21 of FIGS. 1A-1B, suitable for implementing examples according to one example. The quantum computing device 90 may comprise any suitable quantum computing device or devices. The quantum computing device 90 can operate using classical computing principles or quantum computing principles. When using quantum computing principles, the quantum computing device 90 performs computations that utilize quantum-mechanical phenomena, such as superposition and entanglement. The quantum computing device 90 may operate under certain environmental conditions, such as at or near zero degrees)(0° Kelvin. When using classical computing principles, the quantum computing device 90 utilizes binary digits that have a value of either zero (0) or one (1).

The quantum computing device 90 includes a processor device 92 and a system memory 94. The processor device 92 can be any commercially available or proprietary processor suitable for operating in a quantum environment. The system memory 94 may include volatile memory 96 (e.g., random-access memory (RAM)). The quantum computing device 90 may further include or be coupled to a non-transitory computer-readable medium such as a storage device 98. The storage device 98 and other drives associated with computer-readable media and computer-usable media may provide non-volatile storage of data, data structures, computer-executable instructions, and the like. The storage device may also provide functionality for storing one or more qubits 100(0)-100(N).

A number of modules can be stored in the storage device 98 and in the volatile memory 96, including an operating system 102 and one or more modules. All or a portion of the examples may be implemented as a computer program product 104 stored on a transitory or non-transitory computer-usable or computer-readable medium, such as the storage device 98, which includes complex programming instructions, such as complex computer-readable program code, to cause the processor device 92 to carry out the steps described herein. Thus, the computer-readable program code can comprise computer-executable instructions for implementing the functionality of the examples described herein when executed on the processor device 92.

An operator may also be able to enter one or more configuration commands through a keyboard (not illustrated), a pointing device such as a mouse (not illustrated), or a touch-sensitive surface such as a display device (not illustrated). The quantum computing device 90 may also include a communications interface 106 suitable for communicating with other quantum computing systems, including, in some implementations, classical computing devices.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a classical computing system comprising one or more processor devices, a first quantum service request executable by a quantum computing system comprising a plurality of quantum computing devices, each quantum computing device of the plurality of quantum computing devices comprising a plurality of qubits of a qubit type;
providing, by the classical computing system, the first quantum service request to each of a plurality of simulator processes executing on the classical computing system for a simulated execution of the first quantum service request, each simulator process of the plurality of simulator processes based on a hardware profile of one of the plurality of quantum computing devices, the hardware profile comprising the qubit type of the plurality of qubits; and
receiving, by the classical computing system from each simulator process of the plurality of simulator processes, first simulation results of execution of the first quantum service request.

2. The method of claim 1, further comprising:
receiving, by the classical computing system, hardware information from a quantum computing device of the plurality of quantum computing devices, the hardware information comprising the qubit type of the plurality of qubits of the quantum computing device;
generating, by the classical computing system, the hardware profile based on the hardware information; and
storing, by the classical computing system, the hardware profile in a quantum hardware profile repository.

3. The method of claim 2, wherein receiving, by the classical computing system, the hardware information from the quantum computing device, the hardware information comprising the qubit type of the plurality of qubits of the quantum computing device further comprises:
receiving, by the classical computing system, the hardware information from the quantum computing device, the hardware information comprising the qubit type of the plurality of qubits of the quantum computing device, the qubit type comprising photon, coherent state of light, electron, nucleus, optical lattices, Josephson junction, singly charged quantum dot pair, quantum dot, Gapped topological system, or van der Waals heterostructure.

4. The method of claim 2, wherein receiving, by the classical computing system, the hardware information from the quantum computing device, the hardware information comprising the qubit type of the plurality of qubits of the quantum computing device further comprises:
receiving, by the classical computing system, the hardware information from the quantum computing device, the hardware information comprising the qubit type of the plurality of qubits of the quantum computing device and at least one of a temperature, noise, error rate, last time rebooted, or hardware load.

5. The method of claim 1, wherein causing, by the classical computing system, execution of the first quantum service request by each of the plurality of simulator processes further comprises:
inputting the first quantum service request into each of the plurality of simulator processes, the first quantum service request comprising a QASM (quantum assembly language) file.

6. The method of claim 1, wherein receiving, by the classical computing system from each simulator process of the plurality of simulator processes, the first simulation results of execution of the first quantum service request further comprises:
receiving, by the classical computing system from each simulator process of the plurality of simulator processes, the first simulation results of execution of the first quantum service request, the first simulation results comprising at least one of execution time, number of errors, or system impact.

7. The method of claim 1, further comprising forwarding, by the classical computing system, the first simulation results of each of the plurality of simulator processes to a user computing device.

8. The method of claim 1, further comprising determining, by the classical computing system, an optimal qubit type to optimize execution of the first quantum service request.

9. The method of claim 8, further comprising sending, by the classical computing system, an optimized first quantum service request to a scheduler, the optimized first quantum service request comprising the first quantum service request, and identification of the optimal qubit type.

10. The method of claim 8, further comprising determining, by the classical computing system, from a plurality of quantum computing devices comprising the optimal qubit type, an optimal quantum computing device to optimize execution of the first quantum service request.

11. The method of claim 10, further comprising sending, by the classical computing system, an optimized first quantum service request to a scheduler, the optimized first quantum service request comprising the first quantum service request, and identification of the optimal quantum computing device.

12. The method of claim 8, wherein determining, by the classical computing system, the optimal qubit type to optimize execution of the first quantum service request further comprises:
determining the optimal qubit type based on at least one of fastest execution time, fewest errors, minimized system impact, or minimized environmental impact.

13. The method of claim 1, further comprising:
receiving, by the classical computing system, a second quantum service request for execution by the quantum computing system;
causing, by the classical computing system, execution of the second quantum service request by each of the plurality of simulator processes; and
receiving, by the classical computing system from each simulator process of the plurality of simulator processes, second simulation results of execution of the second quantum service request.

14. The method of claim 13, further comprising:
determining, by the classical computing system, a first optimal qubit type to optimize execution of the first quantum service request and a second optimal qubit type to optimize execution of the second quantum service request.

15. The method of claim 13, further comprising determining, by the classical computing system, from the plurality of quantum computing devices, a first optimal quantum computing device to execute the first quantum service request and a second optimal quantum computing device to execute the second quantum service request to optimize execution by a quantum computing system.

16. The method of claim 15, wherein determining, by the classical computing system, from the plurality of quantum computing devices, the first optimal quantum computing device to execute the first quantum service request and the second optimal quantum computing device to execute the second quantum service request to optimize execution by the quantum computing system further comprises:
determining, by the classical computing system, from the plurality of quantum computing devices, the first optimal quantum computing device to execute the first quantum service request and the second optimal quantum computing device to execute the second quantum service request to optimize execution by the quantum computing system, wherein optimizing execution by the quantum computing system comprises at least one of fastest execution time, fewest errors, minimized system impact, or minimized environmental impact across the quantum computing system.

17. A classical computing system comprising:
a processor device to:
receive a first quantum service request executable by a quantum computing system comprising a plurality of quantum computing devices, each quantum computing device of the plurality of quantum computing devices comprising a plurality of qubits of a qubit type;
provide the first quantum service request to each of a plurality of simulator processes executing on the classical computing system for a simulated execution of the first quantum service request, each simulator process of the plurality of simulator processes based on a hardware profile of one of the plurality of quantum computing devices, the hardware profile comprising the qubit type of the plurality of qubits; and
receive, from each simulator process of the plurality of simulator processes, first simulation results of execution of the first quantum service request.

18. The classical computing system of claim 17, wherein the processor device is further to determine an optimal qubit type to optimize execution of the first quantum service request.

19. The classical computing system of claim 17, wherein the processor device is further to:
receive a second quantum service request for execution by the quantum computing system;
cause execution of the second quantum service request by each of the plurality of simulator processes;
receive, from each of the plurality of simulator processes, second simulation results of execution of the second quantum service request; and
determine, from the plurality of quantum computing devices, at least one optimal quantum computing device to optimize execution of the first quantum service request and the second quantum service request.

20. A computer program product stored on a non-transitory computer-readable storage medium and including instructions to cause a processor device of a classical computing system to:
receive a first quantum service request executable by a quantum computing system comprising a plurality of quantum computing devices, each quantum computing device of the plurality of quantum computing devices comprising a plurality of qubits of a qubit type;
provide the first quantum service request to each of a plurality of simulator processes executing on the classical computing system for a simulated execution of the first quantum service request, each simulator process of the plurality of simulator processes based on a hardware profile of one of the plurality of quantum computing devices, the hardware profile comprising the qubit type of the plurality of qubits; and
receive, from each simulator process of the plurality of simulator processes, first simulation results of execution of the first quantum service request.
